(19) United States
(12) Patent Application Publication
(10) Pub. No.: US 2006/0220820 A1
(43) Pub. Date: Oct. 5, 2006

(54) Speed awareness system

(76) Inventor: Alan Taylor, Oswestry (GB)

Correspondence Address: THE WEBB LAW FIRM, P.C., 700 KOPPERS BUILDING, 436 SEVENTH AVENUE, PITTSBURGH, PA, 15219, US

(21) Appl. No.: 11/374,944

(22) Filed: Mar. 14, 2006

(30) Foreign Application Priority Data
Mar. 15, 2005 (GB) 0505261.8

(51) Int. Cl. B60Q 1/54

(52) U.S. Cl. 340/466; 73/116

(57) ABSTRACT

A motor vehicle having means for indicating the speed of the vehicle, which is visible from outside of the vehicle. The speed indicating means may be in the form of a sign, which may be placed on the rear of the vehicle or in the rear window of the vehicle.

### BACKGROUND OF THE INVENTION

1. Field of the Invention

This invention concerns a speed awareness system for motor vehicles.

2. Description of the Related Art

Speeding by motorists is a constant problem, in spite of speed cameras and random police speed checks. Of course, every motor vehicle has a speedometer, so that motorists have no reason for not knowing the speed at which they are traveling. Some vehicles are now even provided with speed limiting systems that operate above a predetermined speed. These systems are useful for motorway driving but in town and cities where speed limits change frequently, such systems are of no real use.

### SUMMARY OF THE INVENTION

An object of this invention is to provide a system for increasing awareness of the speed of a motor vehicle.

According to the invention it is proposed that a motor vehicle be provided with means for indicating the speed of the vehicle that is visible from outside of the vehicle.

Preferably a motor vehicle will have a sign to show the speed of the vehicle. The sign may be provided on the outside of the vehicle, such as on the rear of the vehicle. Alternatively, the sign may be within the vehicle but visible through a window thereof, especially the rear window.

The speed indicating means of the invention preferably derives its speed information from the vehicle's own speedometer. Preferably a wire connection is made between the speedometer and the speed indicating means. Alternatively a non-wired connection may be made between the speedometer and the speed indicating means.

As speedometers in different makes and models of motor vehicle operate differently, it may be necessary to calibrate the speed indicating means of the invention.

The speed indicating means may be powered by the vehicles own electrical power supply. Alternatively, a separate power supply may be provided for the speed indicating means, such as by means of a battery.

The speed indicating means is preferably an illuminated sign. The sign may be arranged to become brighter as the speed of the vehicle increases. Alternatively, the sign may become brighter when a vehicle is braking. Another variation may be to have the colour of the sign change as the speed of the vehicle moves from one range to another, such as appearing in a different colour every 10 miles or 10 km per hours.

The speed indicating means may be linked to a GPS system, which has speed limit information, so that the nature of the speed indication can be altered in accordance with the actual speed limit applying to a particular section of road. For example, a motor vehicle speed that is within the speed limit might appear in one colour, such as green or yellow, and a motor vehicle speed over the speed limit might be shown in red. The speed shown that is over the speed limit may be made to flash or appear brighter.

The speed indicating means of the invention may take any suitable form. Desirably, the speed indicating means may be in the form of a thin flexible membrane that may be adhered to a window of the motor vehicle. Preferably, the membrane type speed indicating means allows visibility out of the window of the vehicle.

The speed indicating means of the invention offers the advantage that the speed of a motor vehicle is made public. This will increase both pedestrians and vehicle users of the speed of motor vehicles. Followers of a motor vehicle will also be aware of their own speed without having to take their eyes off the road. This should make for a motor speed conscious environment. Also, official control and monitoring of vehicle speeds will be easier.

This invention will now be further described, by way of example, with reference to the accompanying drawings, in which:

### BRIEF DESCRIPTION OF THE DRAWINGS

FIG. 1 is a schematic diagram illustrative of the present invention;

FIG. 2 is a schematic view of one embodiment of the present invention; and

FIG. 3 is a schematic view of another embodiment of the present invention.

### DETAILED DESCRIPTION OF THE PREFERRED EMBODIMENTS

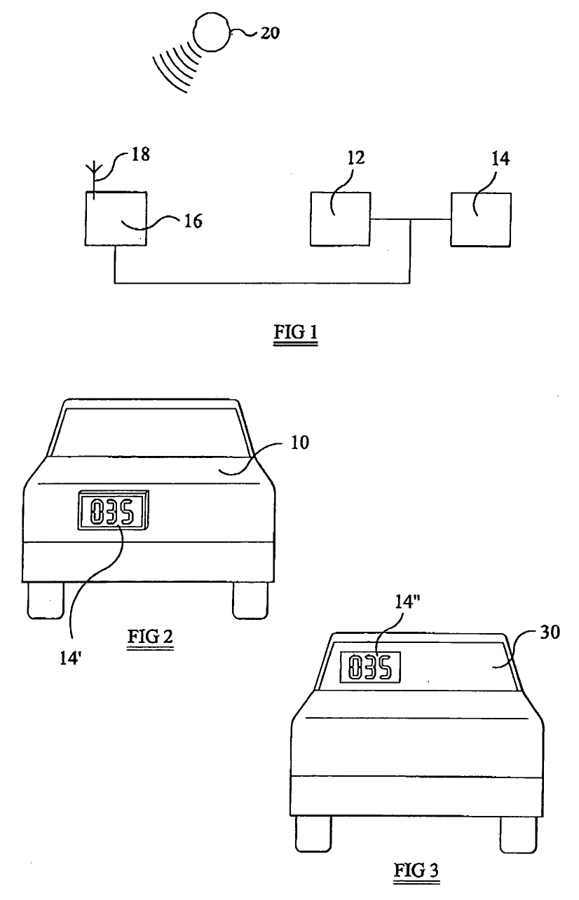

Referring to FIG. 1 of the accompanying drawings, a motor vehicle has a speedometer 12 situated in its dashboard. The speedometer receives a pulsed digital signal from a speed measuring device 14 associated with a wheel or axle of the vehicle in order to display on the speedometer the speed at which the vehicle is traveling.

The signal from the speed measuring device is taken to a display device 16 mounted at the rear of the vehicle also to show the speed of the vehicle. It may be necessary to calibrate the display device, to allow for different types or frequencies of signals provided by the speed meanings device.

The display device could be mounted on the rear of the vehicle or could be mounted in the rear windscreen as shown in FIGS. 2 and 3 of the drawings respectively.

The display device 16 is also associated with a receiver 18 for receiving GPS signals from a source 20, in order to be able to control the display to indicate a relationship between the speed of the vehicle and the speed limit for the road on which the vehicle is moving, which is available via the GPS system. For example the speed display could be made brighter or appear in a different colour if the speed of the vehicle is above the set speed limit for the road. Additionally or alternatively an additional sign could be shown on the display device to indicate when the speed of the vehicle is in excess of the set limit for the road.

In FIG. 2 of the accompanying drawings, motor vehicle 10 has a display device 14 in the form of an illuminated sign that is affixed to the outside of the rear of the vehicle but wired through to receive the signal from the speed measuring device of the vehicle.

In FIG. 3 of the accompanying drawings, motor vehicle 30 has its speed display device 14 in the form of a membrane adhered to the inside of the rear window of the vehicle.

1-48. (canceled)

49. A motor vehicle, comprising means for indicating the speed of the vehicle, wherein the speed of the vehicle is visible from outside of the vehicle.

50. The motor vehicle as claimed in claim 49 having a sign to show the speed of the vehicle.

51. The motor vehicle as claimed in claim 50, wherein the sign is:
(i) provided on the outside of the vehicle;
(ii) on a rear of the vehicle;
(iii) within the vehicle and visible through a window thereof, (iv) within the vehicle and visible through a rear window thereof, or any combination thereof.

52. The motor vehicle as claimed in claim 49, wherein the speed indicating means derives speed information from a vehicle speedometer.

53. The motor vehicle as claimed in claim 52, wherein the speed indicating means is:
(i) in a wired connection with the speedometer;
(ii) in a wireless connection with the speedometer;
(iii) calibrated relative to the speedometer, or any combination thereof.

54. The motor vehicle as claimed in claim 49, wherein the speed indicating means is powered by a vehicle electrical power supply.

55. The motor vehicle as claimed in claim 49, wherein a power supply independent of a vehicle electrical power supply is provided for the speed indicating means.

56. The motor vehicle as claimed in claim 55, wherein the independent power supply comprises a battery.

57. The motor vehicle as claimed in claim 49, wherein the speed indicating means is an illuminated sign.

58. The motor vehicle as claimed in claim 57, wherein: the sign is arranged to become brighter as the speed of the vehicle increases; the sign is arranged to become brighter when the vehicle is braking; a color of the sign is arranged to change as the speed of the vehicle moves from one range to another; the sign is arranged to appear in a different color every 10 miles or 10 km per hour, or any combination thereof.

59. The motor vehicle as claimed in claim 49, wherein the speed indicating means is linked to a GPS system, which includes speed limit information, such that the nature of the speed indication can be altered in accordance with the actual speed limit applying to a particular section of road.

60. The motor vehicle as claimed in claim 59, wherein:
(i) the motor vehicle speed that is within a prescribed speed limit is arranged to appear in one color and a motor vehicle speed over a prescribed speed limit is shown in another color;
(ii) the speed indicating means is arranged to flash when the motor vehicle speed is over a prescribed speed limit;
(iii) the speed indicating means is arranged to appear brighter when the motor vehicle speed is over a prescribed speed limit, or any combination thereof.

61. The motor vehicle as claimed in claim 49, wherein the speed indicating means is in the form of a flexible membrane configured to be adhered to a window of the motor vehicle.

62. The motor vehicle as claimed in claim 61, wherein the membrane-type speed indicating means allows visibility out of the window of the vehicle.

63. A speed indicating means for a motor vehicle, wherein the speed indicating means indicates the speed in manner where the speed is visible from outside of the vehicle.

64. The means as claimed in claim 63, wherein the speed indicating means comprises a sign to show the speed of the vehicle.

65. The means as claimed in claim 63, wherein the speed indicating means is arranged to derive its speed information from a vehicle speedometer.

66. The means as claimed in claim 63, wherein the speed indicating means comprises an illuminated sign.

67. The means as claimed in claim 63, wherein the speed indicating means is linked to a GPS system, which includes speed limit information, such that the nature of the speed indication can be altered in accordance with the actual speed limit applying to a particular section of road.

68. The means as claimed in claim 63, wherein the speed indicating means is in the form of a flexible membrane configured to be adhered to a window of the motor vehicle.

69. In combination, a motor vehicle and means for indicating the speed of the vehicle, wherein speed indicated by the means is visible from outside of the vehicle.
